(19) United States
(12) Patent Application Publication
(10) Pub. No.: US 2012/0034929 A1
(43) Pub. Date: Feb. 9, 2012

(54) SYSTEM AND METHOD FOR SHOWING DYNAMIC LOCATION FOR A PLURALITY OF USERS

(75) Inventors: Mitchell Scott Ozer, San Francisco, CA (US); Scott Hotes, Berkeley, CA (US); Tasos Roumeliotis, Orinda, CA (US)

(73) Assignee: WaveMarket, Inc., Emeryville, CA (US)

(21) Appl. No.: 13/010,082

(22) Filed: Jan. 20, 2011

Related U.S. Application Data
(60) Provisional application No. 61/371,693, filed on Aug. 7, 2010.

(51) Int. Cl. H04W 24/00

(52) U.S. Cl. 455/456.1

(57) ABSTRACT

A computer implemented method of displaying locations of a plurality of tracked assets. The method includes receiving at least one request to display a location representation for a plurality of tracked assets. It is determined whether each request is part of a request chain. Location information related to the requests is received. In response to receiving the first of the location information from a request in a request chain or from a request not in a request chain, a message is displayed, and a first location marker indicating the location of the tracked asset is shown in a view of the map. In response to receiving subsequent location information for a request in a request chain, a message is displayed indicating the location of the tracked asset, and a location marker indicating the location of the tracked asset is placed on the map.

### CROSS REFERENCE TO RELATED APPLICATION(S)

This application claims the benefit of U.S. provisional application No. 61/371,693, filed on Aug. 7, 2010, which is incorporated by reference as if fully set forth.

### BACKGROUND

Many mobile devices such as cellular telephones, smart phones, PDAs, tablets, and the like have the ability to perform network scans to determine radio signal information, such as identifiers associated with nearby cellular base transceiver stations, WiFi™ access points and Bluetooth™ access points. Mobile devices may be further enabled to perform signal strength estimates and other signal measurements. Base transceiver stations and radio access points are primarily used for voice and data service access to the mobile device, but due to their relative permanence can be exploited for other purposes, including determining device location. Mobile devices are frequently further enabled to receive signals from Global Positioning System (GPS) satellites for estimating mobile device location coordinates.

A number of approaches exist to translate terrestrial signal information into location, including cell triangulation and trilateration techniques, such as Time Difference of Arrival (“TDOA”), Enhanced Observed Time Difference (“EOTD”), Advanced Forward Link Trilateration (“AFLT”) and Enhanced Cell Identification (“E-CID”). Such methods are considered terrestrial counterparts to the GPS satellite-based system which uses a form of triangulation based on satellite positioning. A mobile device may be configured for determining its own location, or in some cases, a remote system in communication with a mobile device can be configured to determine a mobile device's location using translation methods such as those described above.

It would be desirable to provide a method of displaying the locations of multiple tracked assets in real time and asynchronously. It would further be desirable to provide a method for displaying the locations of multiple tracked assets that allows a user to focus on the information currently displayed.

### SUMMARY

An example embodiment of the invention provides a computer implemented method of displaying locations of a plurality of tracked assets. The method includes receiving at least one request to display a location representation for a plurality of tracked assets. It is determined whether each request is part of a request chain where the request is at least one of: 1) was received while at least one other request in the request chain was pending and 2) was pending while another request in the request chain was received. Location information related to the requests is received. In response to receiving the first of the location information from a request in a request chain or from a request not in a request chain; a message is displayed indicating the location of the tracked asset, and a first location marker indicating the location of the tracked asset is placed on a map and a view of the map is displayed appropriately scaled and centered to show the first location marker. In response to receiving subsequent location information for a request in a request chain, a message is displayed indicating the location of the tracked asset, and a location marker indicating the location of the tracked asset is placed on the map, and the scale and center of the view of the map is substantially maintained.

Another example embodiment of the invention is a system for displaying location representations of a plurality of tracked assets comprising at least one computing device including at least one memory comprising instructions operable to enable the computing device to perform a procedure. The procedure includes receiving at least one request to display a location representation for a plurality of tracked assets. It is determined whether each request is part of a request chain where the request is at least one of: 1) was received while at least one other request in the request chain was pending and 2) was pending while another request in the request chain was received. Location information related to the requests is received. In response to receiving the first of the location information from a request in a request chain or from a request not in a request chain; a message is displayed indicating the location of the tracked asset, and a first location marker indicating the location of the tracked asset is placed on a map and a view of the map is displayed appropriately scaled and centered to show the first location marker. In response to receiving subsequent location information for a request in a request chain, a message is displayed indicating the location of the tracked asset, and a location marker indicating the location of the tracked asset is placed on the map. Also, the scale and center of the view of the map is substantially maintained.

Yet another example embodiment of the invention is a non-transitory computer-readable media tangibly embodying a program of instructions executable by a computing device to implement a method. The method includes receiving at least one request to display a location representation for a plurality of tracked assets. It is determined whether each request is part of a request chain where the request is at least one of: 1) was received while at least one other request in the request chain was pending and 2) was pending while another request in the request chain was received. Location information related to the requests is received. In response to receiving the first of the location information from a request in a request chain or from a request not in a request chain; a message is displayed indicating the location of the tracked asset, and a first location marker indicating the location of the tracked asset is placed on a map and a view of the map is displayed appropriately scaled and centered to show the first location marker. In response to receiving subsequent location information for a request in a request chain, a message is displayed indicating the location of the tracked asset, and a location marker indicating the location of the tracked asset is placed on the map and the scale and center of the view of the map is substantially maintained.

Another example embodiment of the invention is a computer implemented method of displaying locations references of tracked assets. The method includes receiving at least a request to display a location reference of a tracked asset. Location information related to the request is received. A message is displayed indicating the location of the tracked asset based on the following. In response to the location of the tracked asset being within a predetermined distance from a user-created landmark, a message is displayed indicating the tracked asset's proximity to the user-created landmark. Otherwise if the tracked asset location is a predetermined distance from a public point of interest then a message is displayed indicating the tracked asset's proximity to the public point of interest. Otherwise if the location is not within a predetermined distance from the user-created landmark and is not within a predetermined distance from a public point of interest, then a message is displayed including an address of the location of the tracked asset or the closest intersection to the first location of the tracked asset. Further example embodiments include a system comprising instructions operable to enable the computing device to perform the method above and non-transitory computer-readable media tangibly embodying a program of instructions executable by a computing device to implement the method above.

### BRIEF DESCRIPTION OF THE DRAWING(S)

The foregoing summary as well as the following detailed description will be readily understood in conjunction with the appended drawings which illustrate some example embodiments of the invention. In the drawings:

FIG. 1 is a schematic illustration of an exemplary operating environment in which example embodiments of the invention may operate.

FIG. 2 is a flow chart showing a computer implemented method for displaying location references for tracked assets according to an example embodiment.

FIG. 3 is a screen shot of a display of a user interface where one tracked asset location reference is shown according to an example embodiment of the invention.

FIG. 4 is a screen shot of a display of a user interface where requests for location references for several tracked assets are received according to an example embodiment of the invention.

FIG. 5 is a screen shot of a display of a user interface where location information is received for two tracked assets according to an example embodiment of the invention.

FIG. 6 is a diagram illustrating two request chains according to an example embodiment of the invention.

FIG. 7 is a screen shot of a display showing a user interface where a button is selected to request location references for more than one tracked assets according to an example embodiment of the invention.

### DETAILED DESCRIPTION OF THE EXAMPLE EMBODIMENT(S)

The example embodiments of the invention are described below with reference to the drawing Figures where like numerals represent like elements throughout.

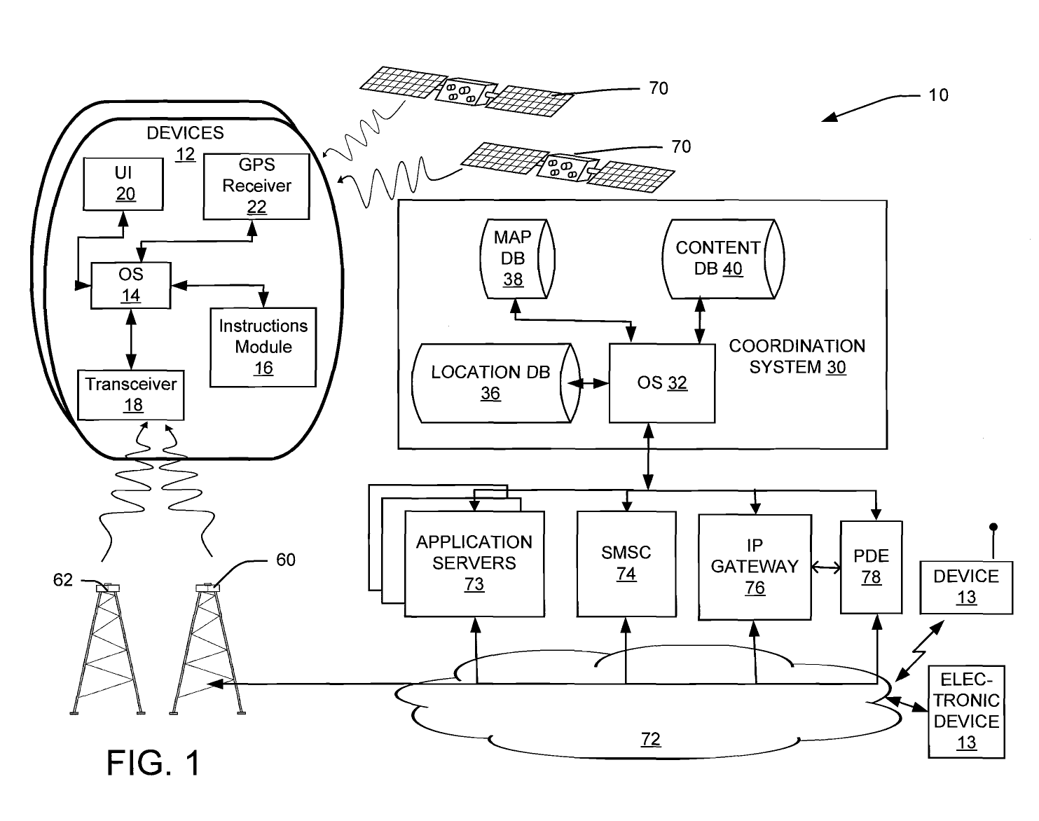

Referring to FIG. 1, a schematic illustration of an exemplary operating environment 10 in which mobile device communication systems, in the form of tracked assets 12 (e.g., mobile devices), electronic devices 13 and a coordination system 30, can be used. The mobile devices 12, electronic devices 13, and coordination system 30 each include one or more computing devices and one or more memory devices, which computing devices and memory devices can be integrally constructed or connected in any suitable manner, for example via a network. It is to be understood that a system or server comprises a computer system, as known in the art.

Each tracked asset 12 (e.g., mobile device) can provide a platform according to an example embodiment of the invention which enables an operating system 14 and a module of instructions 16 preferably residing in a memory of the mobile device 12. The mobile device 12, which preferably includes cellular telephone functionality, includes a transceiver 18 for communication with cellular base transceiver stations 60, 62 (“base stations”) and a user interface 20, preferably including a display and one or more audio speakers. A GPS receiver 22 is preferably provided for receiving signals from GPS satellites 70. The transceiver 18 can be further configured to communicate with other wireless stations or devices, and the mobile device 12 can alternatively support a plurality of transceivers for communication with a plurality of wireless stations or devices of differing protocols. For example, the tracked asset 12 could be a cell phone connected to the internet via a WiFi™ connection. In addition each electronic device 13 can be a cellular phone, smart phone, PDA, computer, or tablet device connected to the internet via a wireless connection such as a WiFi™ connection. Electronic devices 13 optionally can be tracked. Different combinations of devices are possible, such as a tablet connect to the internet via a blue tooth connection to a cell phone.

The coordination system 30 provides a platform according to an example embodiment of the invention which enables an operating system 32 and memory or memories which permit operation of databases 36, 38, 40. Preferably, collected mobile device location data (e.g., location information) is stored in a location database 36, map data corresponding to roads, addresses and other definable geographic data are stored in a map database 38, and content for distribution to a mobile device user via a mobile device is stored in a content database 40. The coordination system 30 is preferably configured to collect data indicative of mobile device location from the tracked assets 12 (e.g., mobile devices) via a telecommunication network 72 and to associate the tracked assets 12 (e.g., mobile devices) with particular users. The location data is preferably received in the form of tuples. Each tuple preferably includes one or more location coordinates and one or more time stamps respectively associated with the one or more location coordinates. Each tuple also preferably includes an identification (“ID”) relating the tuple to a particular mobile device and a precision indication indicating the precision of the location coordinate.

The tuples or other suitable mobile device location data are preferably received by the coordination system 30 in the form of one or more short message service (“SMS”) messages received from the tracked assets 12 (e.g., mobile devices) via a short message service center (“SMSC”) 74, which may be integrated with the telecommunication network 72. Alternatively, location data can be sent by the tracked assets 12 (e.g., mobile devices) using internet protocol (“TCP/IP”) and received by the coordination system 30 via an internet protocol (“IP”) gateway 76, which may be integrated with the telecommunication network 72. The coordination system 30 can alternatively query a remote position determining entity (“PDE”) 78, a Gateway Mobile Location Center (“GMLC”), or other system for disseminating location data associated with mobile devices, which PDE 78, GMLC or other system may be provided as a service by a telecommunication carrier or other party, and which systems may deliver data to the coordination system 30 via internet protocol through the IP gateway 76 or via other suitable protocol. One or more external application servers 73 execute applications which use location data provided by the tracked assets 12 (e.g., mobile devices) or the coordination system 30 to provide content or services to a user of a particular mobile device.

Electronic devices 13 can be connected with the telecommunication network 72. Electronic devices can be connected to the telecommunication network 72 by wireless networks. Electronic devices can include computers, personal computers, servers, or a mobile devices such as a cell phone, tablet, PDA, laptop, etc. For example, a cell phone or tablet can connect to the internet using a WIFI™ connection.

In an option, location information for tracked assets is retrieved from the coordination system 30 and sent to electronic devices 12, 13.

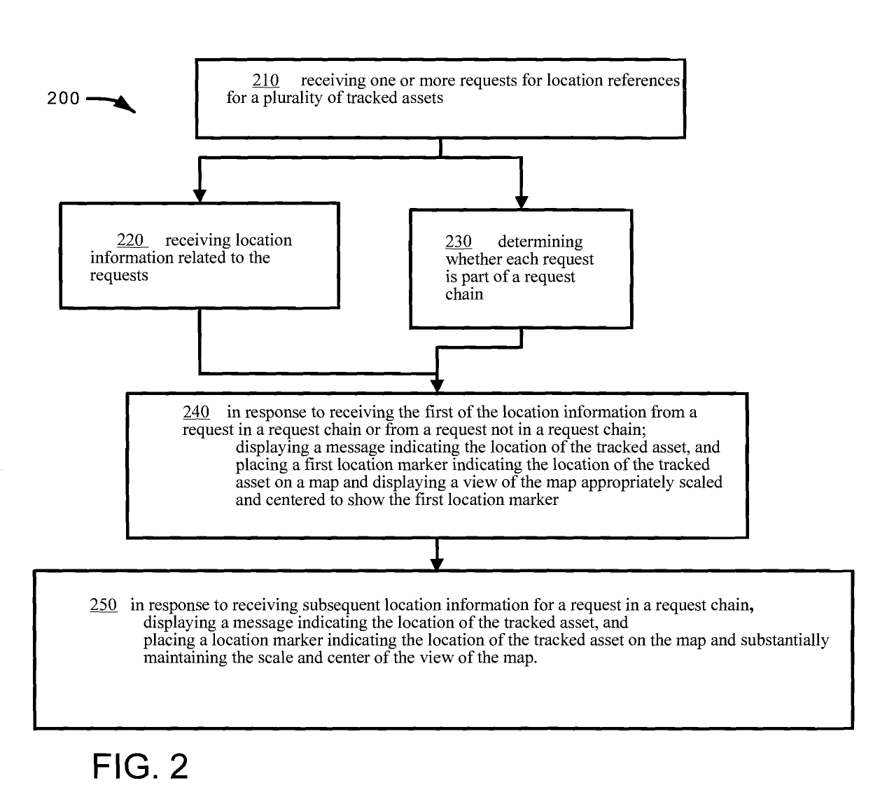

Referring to FIG. 2, a flowchart of an example method 200 for displaying location references of a plurality of tracked assets is shown. Note that the steps can be performed in different orders than shown in the example flowchart. The location references of tracked assets can be shown on an electronic device having a display. The location references can be messages (e.g., displayed or audio) and/or map/graphical representations. The method is described with reference to the example components shown in the operating environment 10 of FIG. 1 wherein at least one or more of the coordination system, mobile devices 12 and electronic devices 13 includes memory suitable for storing instructions for performance of the method 200. Alternatively, the method 200 can be performed by any suitable mobile device or one or more other systems.

The method 200, step 210 includes receiving one or more requests for location representation(s) for a plurality of tracked assets 12. Tracked assets can be any electronic device capable of being tracked, for example, cellular phones, transceivers and GPS tracking devices. An example of a request includes a user selecting an element on a computer screen or on a cell phone display. Background requests can be made by programs that can run on different devices or systems.

In step 230, an electronic device or system determines whether each request is part of a request chain. A request is part of a request chain where the request 1) was received while at least one other request in the request chain was pending, or 2) was pending while another request in the request chain was received.

Still referring to FIG. 2, in step 220, location information is received related to the requests for the locations of the tracked assets. Note that steps 220 and 230 can be performed in any order and can be performed on different devices.

In step 240, in response to receiving the first of the location information from a request in a request chain or from a request not in a request chain; a message is displayed indicating the location of the tracked asset, and a first location marker indicating the location of the tracked asset is placed on a map and a view of the map scaled and centered is displayed to show the first location marker.

In step 250, in response to receiving subsequent location information for a request in a request chain, a message indicating the location of the tracked asset is displayed, and a location marker is placed indicating the location of the tracked asset on the map, and the scale and center of the view of the map is substantially maintained.

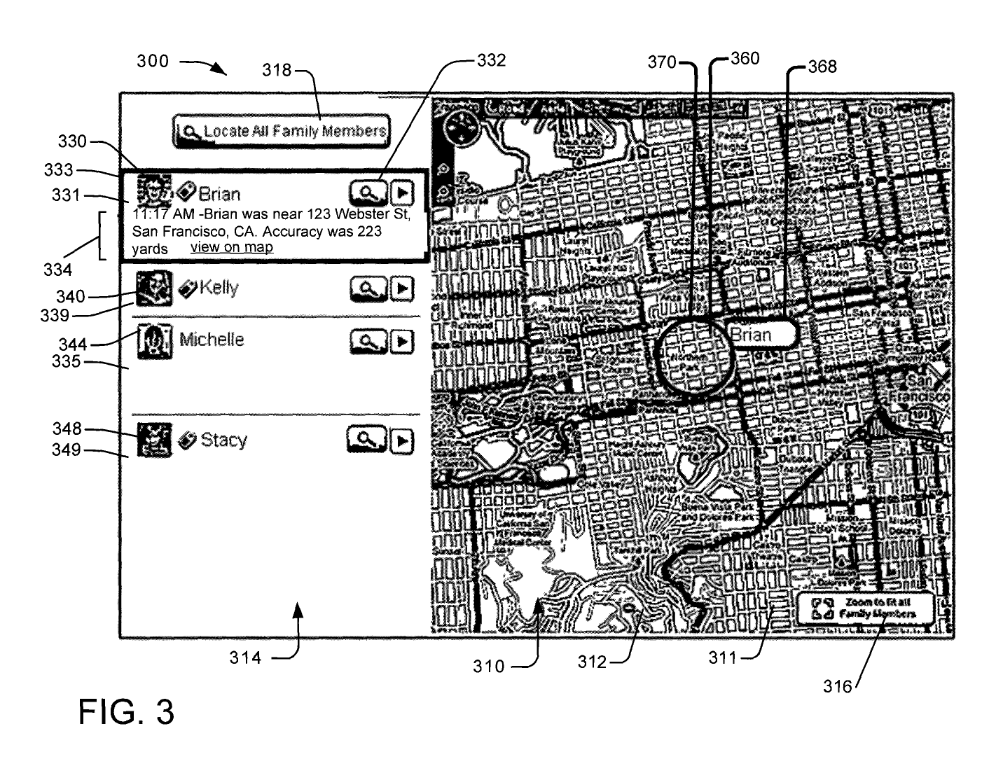

FIG. 3 shows an example of a user interface or display 300 for displaying location indications about tracked assets according to the method 200 of the invention. FIG. 3 can be a user interface on a computer display or a mobile device such as a cell phone, tablet, PDA, laptop or other suitable device. In this example, location references about the location of the tracked assets comprise messages and location markers on a map.

FIG. 3 shows an example layout of a message area 314 and a map area 310. Messages 334 and tracked asset names and symbols 330 are displayed in the message area 314. Symbols 330, 340, 344, 348, and/or names for tracked assets (e.g., family members) can be shown in sections 331, 339, 335, 349, in the message area 314 (e.g., sidebar). View 311 of a map 312 is displayed in the map area 310. View 311 shows a portion of the map 312 that is displayed in the user interface or display 300.

FIG. 3 shows a display where a location reference (e.g., information) about a tracked asset Brian 330 is requested by a user selecting a selectable element (e.g., icon 330 or search icon 332) on the display 300.

Referring to FIG. 2, steps 220, 230 and 240, since this is a single request not part of a request chain (step 240), in response to receiving a request not in a request chain, a message 334 is displayed indicating the location of the tracked asset. A first location marker 370 (comprised of area marker 360 and label 368) indicating the location of the tracked asset is placed on a map and a view 311 of the map appropriately scaled and centered is displayed to show the first location marker 370. If the view of the map was previously centered on another area and with a different scale, the view 311 of the map appropriately scaled and centered is displayed to properly show the first location marker 370. In this example, the location marker 370 is comprised of an area marker 360 (e.g., halo) and a label 368 having the tracked asset's name. The area marker 360 can be a circle or a shaded in circle. The area marker can have an area proportional to the accuracy of the location information. For example, the more accurate or precise the location, the smaller the area of the area marker. If the area marker 360 gets below a predetermined size, an asset icon is displayed in place of the area marker. An asset icon is a symbol or icon that represents the tracked asset. An asset icon preferably has a minimum size (e.g., radius, area) so that it is recognizable to the user and the asset icon preferable has a fixed size.

FIG. 3 also shows a selectable element (e.g., button) 318 to send a request to locate all tracked asset (e.g., family members). A selectable element (e.g., button) 316 is provided to re-center and scale the view of the map so that all tracked assets with location information properly fit into the view 311 of the map.

Messages displayed can describe the location of tracked assets with reference to the proximity of tracked asset to landmark references and the accuracy of the location information. Referring to FIG. 3, message 334 shows that at 11:17 AM Brian was near 123 Webster Street, San Francisco, Calif., and the accuracy was 223 yards. Here the accuracy is shown by using the word “near” and stating the distance 223 yards. If the location was more accurate, the message can state “at” instead of “near”. As stated herein, accuracy can connote accuracy or precision of received location information.

Landmark references can be comprised of different classes, such as user-created landmarks, public point of interests, previously visited locations, street addresses and street intersection information.

The more familiar a user is with a landmark reference, the higher the priority of that landmark reference. User-created landmarks are likely to be most familiar to a user since user-created landmarks were created by the user. Public points of interest can be the next most familiar. If neither user-created landmarks nor public points of interests are nearby, the address or closest intersection of major streets can be referred to in the message.

A method according to the invention comprises displaying the message on an electronics device as follows: if the location of the tracked asset is within a predetermined distance from a user-created landmark, a message is displayed indicating the tracked asset's proximity to the user-created landmark. Otherwise, if the tracked asset location is a predetermined distance from a public point of interest then a message is displayed indicating the tracked asset's proximity to the public point of interest. Otherwise, a message is displayed indicating the address of the location of the tracked asset or the closest intersection to the location of the tracked asset.

For example, if the asset is located within a predetermined distance from a user-created landmark, the asset can be indicated as “at” or “near” that landmark, depending on the accuracy of the locate. “Brian was located near Hendrick Middle School”. This is the strongest option in terms of context, as the user will have a high level of familiarity with the landmarks that they have created.

If the tracked asset is located within a predetermined distance from a public point of interest (POI), the asset can be indicated as “at” or “near” that POI, depending on the accuracy of the locate. For example, “Brian was located near Jim's Coffee Shop at 453 Main Street”. Despite the asset not being located near a user-defined landmark, this option still provides more context than simply an address. This option becomes stronger as artificial intelligence is employed to gather information about typical user behaviors. For example, if data indicates that a phone belonging to an overseeing user such as a parent is often located in a Starbucks™ cafe at the corner of Main Street and 4^{th} Ave, then the next time a phone belonging to a person being monitored by the overseeing user such as a child is located near that intersection, Starbucks™ cafe can be called out as the nearby POI, since it is likely that the parent is familiar with it. If the asset is not located near a Landmark or POI, the full street address or the closest intersection can be displayed. Immediately following the address and accuracy of the locate can be a “View on Map” link that allows the user to view the locate on the map. Clicking the link will re-center and re-zoom the view on the appropriate tracked asset.

FIG. 3 shows an embodiment of the user interface that includes displaying a first user selectable element 316 (e.g. button) that when selected scales and centers the view of the map to include location markers for all tracked assets with location information.

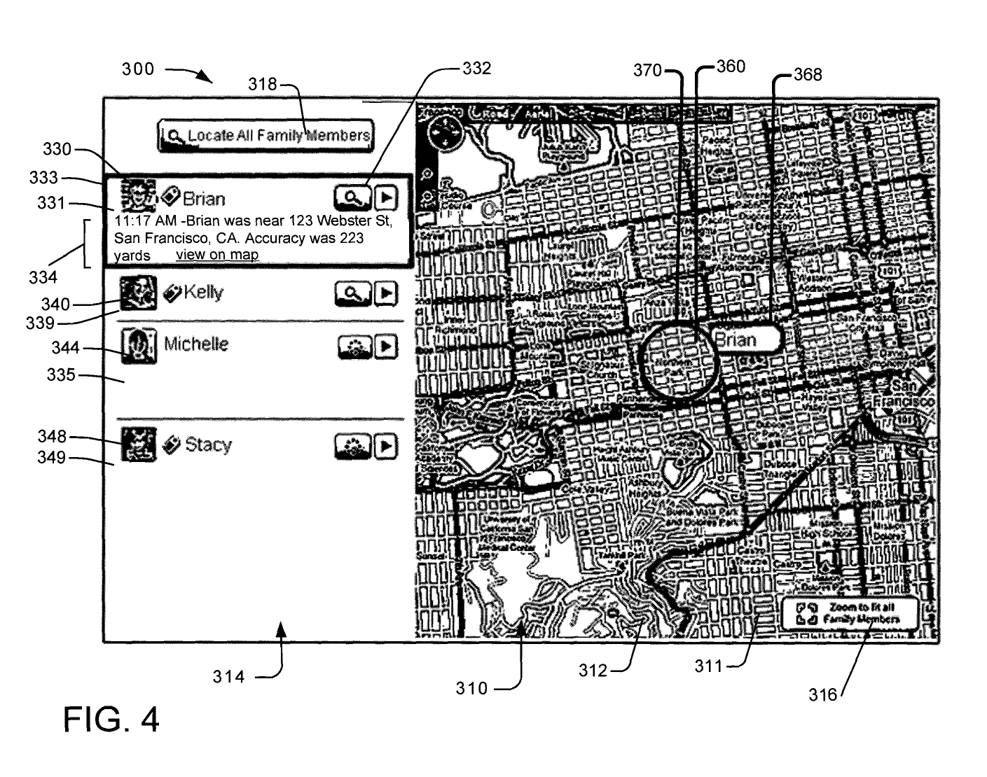

FIG. 4 shows a display where requests were made for several tracked assets in a request chain. For example, requests for Brian, Kelly, Michelle and Stacy can be made sequentially in a chain or by pressing the “locate all family members” button where requests for locations of Brian, Kelly, Michelle and Stacy are made essentially simultaneously and are in one request chain.

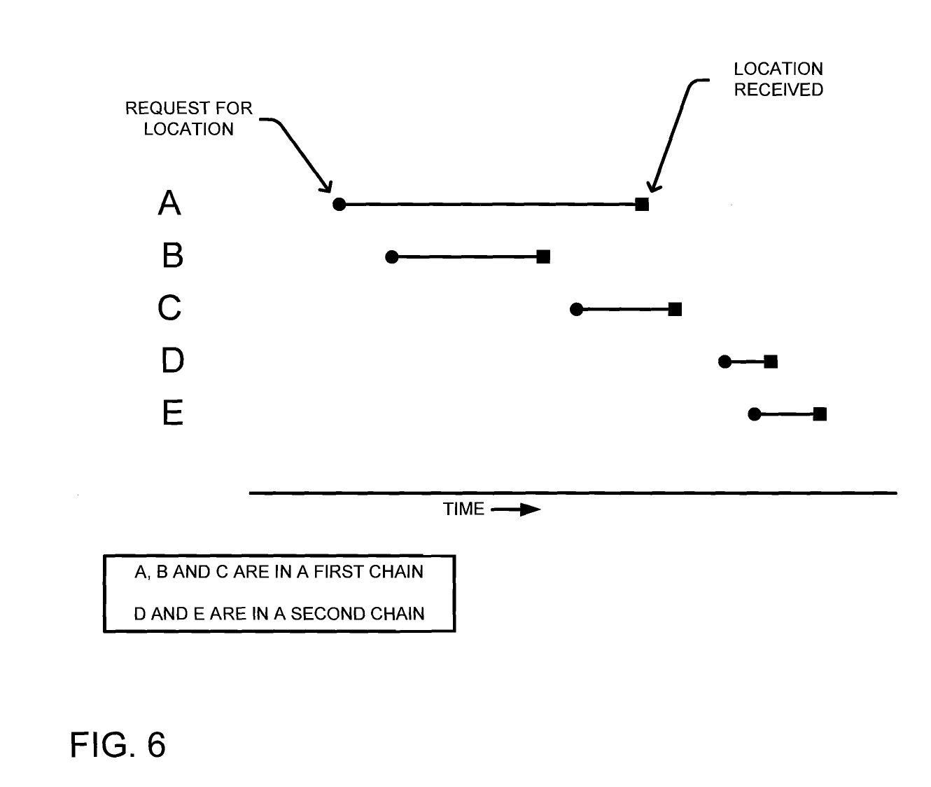

As shown in FIG. 2, step 230, an electronic device determines whether each request is part of a request chain. A request is part of a request chain where the request is at least one of: 1) was received while at least one other request in the request chain was pending and 2) was pending while another request in the request chain was received. FIG. 6 shows examples of request chains.

In the example shown in FIG. 4, Brian's location information is received first and the request for Brian's location is in the request chain for Brian, Kelly, Michelle and Stacy. Brian's location message 334 is displayed. When a location result comes in (success or failure) the corresponding asset's section 331 in the message area 314 is updated with the location and a highlight 333 preferably appears behind the section and then can fade after about 3 seconds.

Also, a first location marker 370 is placed indicating the location of the Brian (tracked asset) on a map and a view 311 of the map is displayed appropriately scaled and centered to show the first location marker 370.

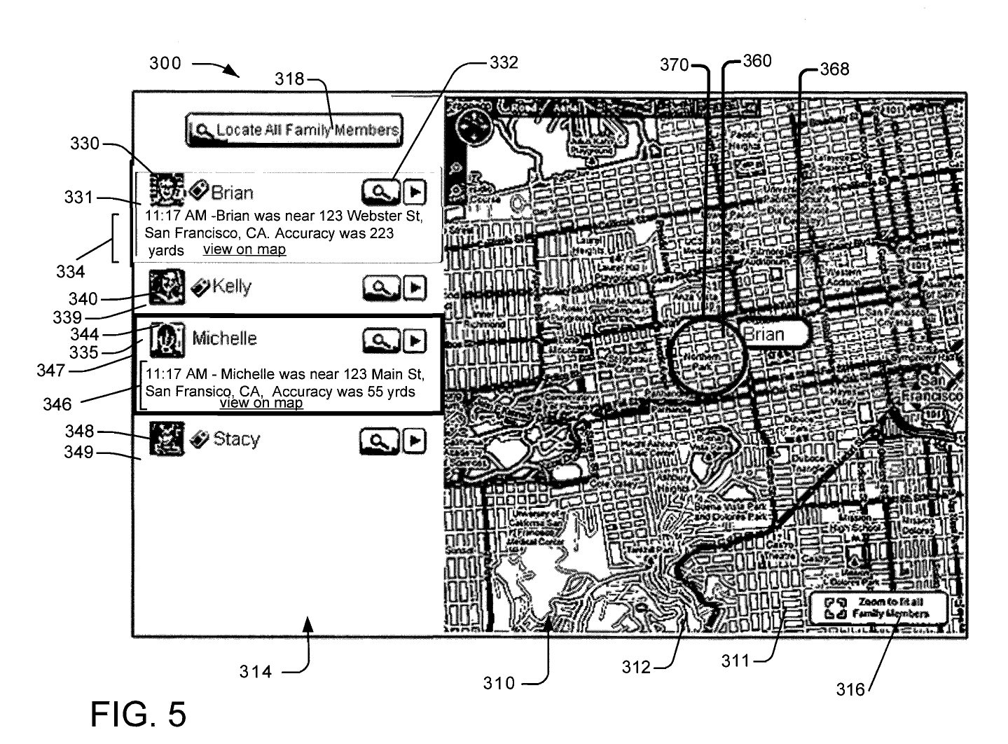

Referring to FIG. 5, a second tracked asset's (Michelle) location then is received. In response to receiving subsequent location information for a request in a request chain, a message 346 is displayed in the asset's section 335 indicating the location of the tracked asset and section 355 is temporarily highlighted 347. Also a location marker indicating the location of the tracked asset is placed on the map 312, but the view 311 of the map 312 substantially maintains the scale and center of the view. In this case, Michelle's location was not in the view 311, so Michelle's location marker is not displayed. Michelle's marker is not visible to a user in the view 311 of the map 312 in the user's viewport (e.g., the user cannot see Michelle's location marker on their display screen). The subsequent remainder of the locates on the chain will not cause the view 331 of map to re-zoom or re-center, thereby allowing the user to maintain focus on their current task. All location markers are placed on one map. Only a portion of the map 312 is displayed in the view 311. The view of the map can be zoomed and panned to re-center on any location marker on the map and that location marker would then be visible to the user in the user's viewport.

If at any point there are no individual requests for locates being performed all “request chains” are broken. Likewise, once the user navigates away from the current view or page, all “request chains” are broken.

For example, a user initiates individual locates for asset “A” and then “B”. Because “A” is being located when “B” is initiated, they form a chain. The location for “A” is then returned. Because it is the first location of the chain returned, the sidebar is updated and highlighted, the location appears on the map, and the map is centered and zoomed to the location. While “B” is still being located, the user initiates a locate for “C”. “C” now joins “B's” chain, which also includes “A”. When the locations of “B” and “C” are returned, the sidebar will display updated messages, the messages will be temporarily highlighted, and the locations will appear on the map. However, the view of the map will not re-center or zoom because a member on the chain (“A”) was already the first to do so.

FIG. 6 shows a chart of the timings for two request changes. The circular balls represent the times when a request is made for location references and the squares represents the times when the location information is received. A request is part of a request chain if the request was received while at least one other request in the request chain was pending and/or 2) the request was pending while another request in the request chain was received. FIG. 6 shows requests A, B, and C in one request chain. Requests D and E are part of another request chain. The two request chains were broken by the time gap between when C location information was received and when D request was made.

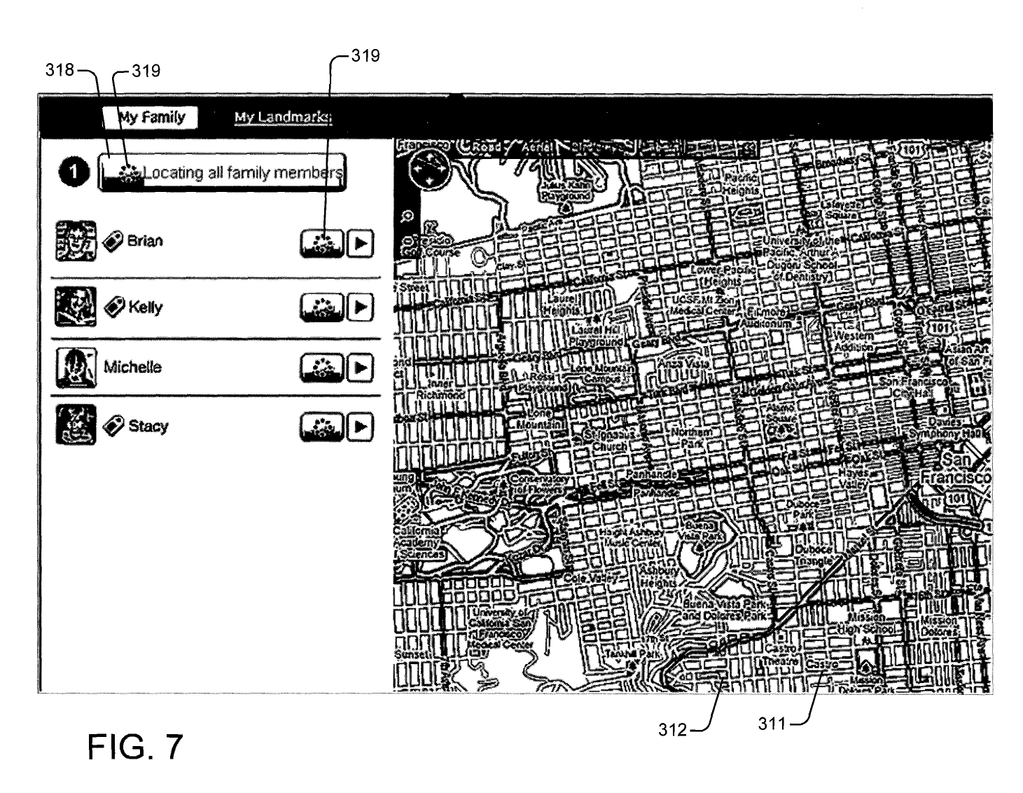

Referring to FIG. 7, in an example display, when the user clicks on the locate all family members button 318, an animated spinner 319 appears and the text in the button changes to “Locating All Family Members”. Each individual locate button displays an animated spinner 319 instead of the magnifying glass. Preferably each button has no effect if clicked again. All previous location markers (e.g., halos) are removed from the view of the map. Each family member is added to an existing “chain” if there is one, or a new one is created if no chain currently exists. Locating all assets follows the “chain” behavior as described above.

Request for location information can be initiated unrelated to a user request. Location information of a tracked asset unrelated to the requests can be received. When this happens, a message is displayed indicating the location of the tracked asset, and a location marker indicating the location of the tracked asset is placed on a map but the view of the map is not changed. That is the scale and center of the view of the map is substantially maintained. This is to prevent the view from changing while a user is viewing the map where the request was not user initiated.

For example, there will be many cases when an asset's location is updated without the user explicitly clicking the locate button for that family member. These cases can include automated locates based on time, locates based on alerts regarding when a device enters a pre-specified area or within proximity to a particular point of interest, or locates performed via other web instances, mobile devices, or remote systems. In these cases, whenever a successful updated location is available, the location updates in the sidebar and a highlight appears behind that asset's section to bring it to the user's attention. The highlight preferably fades after 3 seconds.

If the asset whose location has just been updated previously had a location marker (e.g., halo/label) on the map, the now outdated location marker is removed from the map and the map is populated with the updated location marker. The map preferably does not center or zoom automatically so that if the updated location marker is not in the current view of the map, the updated location marker will not yet be visible to the user.

Other exemplary embodiments include ways that location markers for the tracked assets are displayed on views of a map. When populating the map with the information of multiple assets, the visibility of each of the assets as well as the information found on the map underneath them should be considered. It is best that no important information (street names, building, addresses, etc.) are obscured on the map. Additionally, a simple, clutter-free interface is important to providing a good user experience. With this in mind, the following options for displaying area marker and icons were created.

In an example embodiment, whenever a map is re-centered or re-zoomed, a first location marker is displayed over the approximate first position of a first tracked asset. Location markers can be displayed as either area markers or asset icons. The size of an area marker is proportional to the accuracy or precision of the location information. An asset icon preferably has a fixed size that is large enough to be recognized by a user. By default, an area marker is displayed for the location marker. However, in the view, if the size of the area marker is below a predetermined minimum size, then an asset icon is displayed in place of the area marker. This ensures that the tracked asset is always visible and recognizable by the user. Once the zoom level or accuracy of the location information changes such that the size of the area marker is above the minimum size, the asset icon disappears and the area marked is displayed.

If the first area marker (e.g., halo) is displayed, a first label associated with the first area marker (e.g., halo) can be displayed for a predetermined time (e.g., 3 seconds) when: a) the first area marker (e.g., halo) is first displayed on a map as a result of re-centering or re-zooming a map or a updated first location of the first asset positions the first area marker (e.g., halo) on the map; orb) a request is received to display the first label by a user hovering over the first area marker (e.g., halo) or a user hovers over the first asset section in the display bar. All labels can fade out after about 3 seconds without the user hovering over the asset's area marker (e.g., halo), label or over message sidebar section.

Labels can be displayed so they do not overlap other labels. For example, when first and second labels are shown in the same view, the first and second labels are non-overlapping.

In an option, the first label is connected with a right side of a first mark marker (e.g., halo) and the first label is about horizontal on the map.

The area markers are displayed over the approximate position of tracked assets. The first area marker (e.g., halos) has an area proportional to the accuracy of the first location (e.g., location coordinates). If the map is resized or re-centered and an asset's halo is first displayed on a map (device display) or if the asset's halo is located at a new position (e.g., location update), then the asset's label is displayed for 3 seconds;

For example, as shown in FIG. 3, locate label 368 can be attached to an area marker 360 (e.g., accuracy halos) when they are visible. The length of the label depends on the length of the asset's name. The size of each label is taken into account when determining the zoom level of the map after a locate (e.g., the entire area marker 360 and label 368 should be visible on a view of the map).

In an option, two or more labels should not overlap each other. The default label position can be the upper-right side of the area marker. If two or more labels would overlap, instead, labels after the first should be moved along the perimeter of the area marker (e.g., halo) such that they will not overlap. If possible, the labels should all remain on the right side of the area marker. Labels should preferably always remain horizontal and in contact with the area marker to which they belong.

While example embodiments of the invention have been described in detail above, the invention is not limited to the specific embodiments described above, which should be considered as merely exemplary. Further modifications and extensions of the invention may be developed, and all such modifications are deemed to be within the scope of the invention as defined by the appended claims.

What is claimed is:

1. A computer implemented method of displaying locations of a plurality of tracked assets comprising:
receiving at least one request to display a location representation for a plurality of tracked assets;
determining whether each request is part of a request chain where the request is at least one of:
1) received while at least one other request in the request chain was pending and
2) pending while another request in the request chain was received;
receiving location information related to the requests;
in response to receiving the first of the location information from a request in a request chain or from a request not in a request chain:
displaying a message indicating the location of the tracked asset, and placing a first location marker indicating the location of the tracked asset on a map and displaying a view of the map to show the first location marker; and
in response to receiving subsequent location information for a request in a request chain:
displaying a message indicating the location of the tracked asset, and
placing a location marker indicating the location of the tracked asset on the map and substantially maintaining the scale and center of the view of the map.

2. The method of claim 1 which further comprises displaying said message indicating the location of the track asset based on the location's proximity to landmark references.

3. The method of claim 1 which further comprises:
receiving a landmark reference related to the locations of the tracked assets;
and the step of displaying of said messages further comprises: indicating the relative accuracy of the location information and describing the location of the tracked assets in relation to the landmark reference.

4. The method of claim 3 which further comprises:
said landmark references are comprised of user-created landmarks, public point of interests, and street address and street intersection information, and
displaying the message on an electronics device based on the following:
if the location of the tracked asset is within a predetermined distance from a user-created landmark then displaying a message indicating the tracked asset's proximity to the user-created landmark;
otherwise if the location of the tracked asset is a predetermined distance from a public point of interest then displaying a message indicating the tracked asset's proximity to the public point of interest; and
otherwise displaying a message with the address of the location of the tracked asset or the closest intersection to the location of the tracked asset.

5. The method of claim 1 which further comprises:
receiving location information of a tracked asset unrelated to the requests;
displaying a message indicating the location of the tracked asset, and
placing a location marker indicating the location of the tracked asset on a map and substantially maintaining the scale and center of the view of the map.

6. The method of claim 1 which further comprises:
providing a user interface on an electronic device; the user interface comprises a message area and a map area; messages are displayed in the message area; and a map is displayed in the map area;
the user interface further comprises a first user selectable element that when selected scales and centers the view of the map to include location markers for all tracked assets with location information; and
a second user selectable element that when selected initiates requests for location information for all of the plurality of tracked assets with location information.

7. A system for displaying location representations of a plurality of tracked assets comprising at least one computing device including at least one memory comprising instructions operable to enable the computing device to perform a procedure comprising:
receiving at least one request to display a location representation for a plurality of tracked assets;
determining whether each request is part of a request chain where the request is at least one of:
1) received while at least one other request in the request chain was pending and
2) pending while another request in the request chain was received;
receiving location information related to the requests;
in response to receiving the first of the location information from a request in a request chain or from a request not in a request chain;
displaying a message indicating the location of the tracked asset, and placing a first location marker indicating the location of the tracked asset on a map and displaying a view of the map appropriately scaled and centered to show the first location marker; and
in response to receiving subsequent location information for a request in a request chain, displaying a message indicating the location of the tracked asset, and
placing a location marker indicating the location of the tracked asset on the map and substantially maintaining the scale and center of the view of the map.

8. The system of claim 7 wherein the procedure further comprises: displaying said message indicating the location of the track asset based on the location's proximity to landmark references.

9. The system of claim 7 wherein the procedure further comprises:
receiving a landmark reference related to the locations of the tracked assets;
and the displaying of said messages further comprises indicating the relative accuracy of the location information and describing the location of the tracked assets in relation to the landmark reference.

10. The system of claim 7 wherein the procedure further comprises:
said landmark references are comprised of user-created landmarks, public point of interests, and street address and street intersection information, and
displaying the message on an electronics device based on the following:
if the location of the tracked asset is within a predetermined distance from a user-created landmark then displaying a message indicating the tracked asset's proximity to the user-created landmark; and
otherwise if the location of the tracked asset is a predetermined distance from a public point of interest then displaying a message indicating the tracked asset's proximity to the public point of interest; and
otherwise displaying a message with the address of the location of the tracked asset or the closest intersection to the location of the tracked asset.

11. The system of claim 7 wherein the procedure further comprises:
receiving location information of a tracked asset unrelated to the requests;
displaying a message indicating the location of the tracked asset; and
placing a location marker indicating the location of the tracked asset on a map and substantially maintaining the scale and center of the view of the map.

12. The system of claim 7 wherein the procedure further comprises:
providing a user interface on an electronic device; the user interface comprises a message area and a map area; messages are displayed in the message area; and a map is displayed in the map area;
the user interface further comprises a first user selectable element that when selected scales and centers the view of the map to include location markers for all tracked assets with location information; and
a second user selectable element that when selected initiates requests for location information for all of the plurality of tracked assets with location information.

13. Non-transitory computer-readable media tangibly embodying a program of instructions executable by a computing device to implement a method, the method comprising:
receiving at least one request to display a location representation for a plurality of tracked assets;
determining whether each request is part of a request chain where the request is at least one of:
1) received while at least one other request in the request chain was pending and
2) pending while another request in the request chain was received;
receiving location information related to the requests;
in response to receiving the first of the location information from a request in a request chain or from a request not in a request chain;
displaying a message indicating the location of the tracked asset, and placing a first location marker indicating the location of the tracked asset on a map and displaying a view of the map appropriately scaled and centered to show the first location marker; and
in response to receiving subsequent location information for a request in a request chain, displaying a message indicating the location of the tracked asset, and
placing a location marker indicating the location of the tracked asset on the map and substantially maintaining the scale and center of the view of the map.

14. The non-transitory computer-readable media of claim 13 wherein the procedure further comprises displaying said message indicating the location of the track asset based on the location's proximity to landmark references.

15. The non-transitory computer-readable media of claim 13 wherein the procedure further comprises:
receiving a landmark reference related to the locations of the tracked assets;
and the displaying of said messages further comprises: indicating the relative accuracy of the location information and describing the location of the tracked assets in relation to the landmark reference.

16. The non-transitory computer-readable media of claim 13 wherein the procedure further comprises:
said landmark references are comprised of user-created landmarks, public point of interests, and street address and street intersection information, and
displaying the message on an electronics device based on the following:
if the location of the tracked asset being within a predetermined distance from a user-created landmark then displaying a message indicating the tracked asset's proximity to the user-created landmark; and
otherwise if the location of the tracked asset is a predetermined distance from a public point of interest then displaying a message indicating the tracked asset's proximity to the public point of interest; and
otherwise displaying a message with the address of the location of the tracked asset or the closest intersection to the location of the tracked asset.

17. The non-transitory computer-readable media of claim 13 wherein the procedure further comprises:
receiving location information of a tracked asset unrelated to the requests;
displaying a message indicating the location of the tracked asset, and
placing a location marker indicating the location of the tracked asset on a map and substantially maintaining the scale and center of the view of the map.

18. The non-transitory computer-readable media of claim 13 wherein the procedure further comprises:
providing a user interface on an electronic device; the user interface comprises a message area and a map area; messages are displayed in the message area; and a map is displayed in the map area;
the user interface further comprises a first user selectable element that when selected scales and centers the view of the map to include location markers for all tracked assets with location information; and
a second user selectable element that when selected initiates requests for location information for all of the plurality of tracked assets with location information.

19. A computer implemented method of displaying locations references of tracked assets comprising:
receiving at least a request to display a location reference of a tracked asset;
receiving location information related to the request;
displaying a message indicating the location of the tracked asset based on the following:
in response to the location of the tracked asset being within a predetermined distance from a user-created landmark, displaying a message indicating the tracked asset's proximity to the user-created landmark; and
otherwise if the tracked asset location is a predetermined distance from a public point of interest then displaying a message indicating the tracked asset's proximity to the public point of interest; and
otherwise if the location is not within a predetermined distance from the user-created landmark and is not within a predetermined distance from a public point of interest, then displaying a message with the address of the location of the tracked asset or the closest intersection to the location of the tracked asset.

20. The method of claim 19 which further comprises:
indicating in the message the relative accuracy of the location information; and
receiving landmark references comprising: user-created landmarks, public point of interest, and street address and street intersection information proximate to the first location of first tracked asset.

21. The method of claim 19 wherein the request is received from a user on an electronic device having a display;
the location of a tracked asset is received from a coordination system; and
landmark references are received from the coordination system, wherein the landmark references are comprised of: user-created landmarks, public points of interest, and street address and street intersection information proximate to the location of tracked asset.

22. The method of claim 19 which further comprises displaying the location of the tracked asset in a view of a map.
